(19) United States
(12) Patent Application Publication
(10) Pub. No.: US 2015/0222946 A1
(43) Pub. Date: Aug. 6, 2015

(54) DISPLAY APPARATUS, METHOD FOR CONTROLLING THE SAME, AND COMPUTER-READABLE RECORDING MEDIUM

(71) Applicant: SAMSUNG ELECTRONICS CO., LTD., Suwon-si (KR)

(72) Inventor: Kyung-ju LEE, Seoul (KR)

(73) Assignee: SAMSUNG ELECTRONICS CO., LTD., Suwon-si (KR)

(21) Appl. No.: 14/473,347

(22) Filed: Aug. 29, 2014

(30) Foreign Application Priority Data
Feb. 5, 2014 (KR) 10-2014-0012844

(51) Int. Cl. H04N 21/41; H04N 21/485; H04N 21/472; H04N 5/445; H04N 21/475

(52) U.S. Cl. CPC H04N 21/4126; H04N 5/44543; H04N 21/4755; H04N 21/47205; H04N 21/485; H04N 21/4858; H04N 2005/44569

(57) ABSTRACT

A display apparatus which is connectable to at least one terminal apparatus is disclosed. The display apparatus includes a display, a communicator configured to receive home screen information from the terminal apparatus, and a controller configured to generate a home screen based on the received home screen information and control the display to display the generated home screen.

### CROSS-REFERENCE TO RELATED APPLICATION

This application claims priority from Korean Patent Application No. 10-2014-0012844, filed on Feb. 5, 2014 in the Korean Intellectual Property Office, the disclosure of which is incorporated herein by reference in its entirety.

### BACKGROUND

1. Field

Apparatuses and methods consistent with exemplary embodiments relate to a display apparatus, a method for controlling the display apparatus, and a computer-readable recording medium, and more particularly, to a display apparatus which generates a home screen based on edit information received from a terminal apparatus and provides the home screen to a user, a method for controlling the display apparatus, and a computer-readable recording medium.

2. Description of the Related Art

Smart televisions (TVs) or Internet protocol (IP) TVs provide various functions, such as web surfing, video on demand (VOD), social network service (SNS), and/or games, to a user using Internet-based various types of applications (application programs) installed in the smart TVs or the IP TVs,

To provide these services, real-time broadcasting programs, as well as icons which may execute various pieces of content such as movies, applications, or personal photos, are displayed in the home screens of the smart TVs.

On the other hand, regardless of different personal preferences of a plurality of users using TVs, the home screens in which the preferences are considered may not be provided, and editing arrangements or types of icons displayed in the home screen is cumbersome.

For example, a person A often uses VOD service and SNS service using a smart TV, and a person B often watches real-time broadcasting or the like and wants icons corresponding to frequently used services to be displayed on the home screen. However, regardless of the users using the smart TVs, the same home screen is always provided, and thus user satisfaction may not be improved in this regard.

Further, to change the types and arrangements of the icons displayed on the home screen, the user may have a trouble in activating a separate setup menu.

Therefore, there is a need for a method for providing a home screen that considers a user's taste and easily editing the home screen.

### SUMMARY

One or more exemplary embodiments may overcome the above disadvantages and other disadvantages not described above. However, it is understood that one or more exemplary embodiment are not required to overcome the disadvantages described above, and may not overcome any of the problems described above.

One or more exemplary embodiments provide a display apparatus capable of providing a TV home screen by considering a user's taste and more conveniently editing the home screen by the user, a method for controlling the same, and a computer-readable recording medium.

According to an aspect of an exemplary embodiment, there is provided a display apparatus including: a display; a communicator configured to receive home screen information from at least one terminal apparatus; and a controller configured to generate a home screen based on the received home screen information and control the display to display the generated home screen.

The home screen information may be information regarding a type of at least one piece of content displayed on the home screen or an arrangement state of the content displayed on the home screen.

The display apparatus may further include a storage configured to store the home screen information received from the terminal apparatus.

The controller may be configured to generate a user interface (UI) configured to select a home screen from among a plurality of home screens corresponding to a plurality of pieces of home screen information stored in the storage and control the display to display the UI.

The controller may be configured to generate a UI configured to set a connection state to the at least one terminal apparatus and control the display to display the UI.

The controller may be configured to generate a UI configured to select a terminal apparatus, which is to receive the home screen information, from the at least one terminal apparatus, and control the display to display the UI.

The controller may be configured to control the display to display a home screen set to default in response to the home screen information being not received from the terminal apparatus.

The communicator may be a near field communication (NFC) tag.

The controller may control the display to divide a screen of the display and to display home screens for a plurality of terminal apparatuses in the divided screens in response to pieces of home screen information being received from the plurality of terminal apparatuses.

According to an aspect of another exemplary embodiment, there is provided a method for controlling a display apparatus which is connectable to at least one terminal apparatus. The method may include receiving home screen information from the at least one terminal apparatus; and generating a home screen based on the received home screen information and displaying the home screen on a display of the display apparatus.

The home screen information may be information for a type of at least one piece of content displayed on the home screen or an arrangement state of the content.

The method may further include storing the home screen information received from the terminal apparatus.

The method may further include displaying a user interface (UI) configured to select a home screen from among a plurality of home screens corresponding to a plurality of pieces of home screen information stored in a storage.

The method may further include displaying a UI configured to set a connection state to the at least one terminal apparatus.

The method may further include displaying a UI configured to select a terminal apparatus, which is to receive the home screen information, from the at least one terminal apparatus.

The method may further include determining whether the home screen information is received from the at least one terminal apparatus. The generating of the home screen and displaying of the home screen on the display may include providing a home screen set to default in response to the home screen information being not received from the at least one terminal apparatus.

The receiving of the home screen information from the terminal apparatus may include receiving the home screen information in a near field communication (NFC) tag.

The displaying in the display may include dividing a screen of the display and displaying home screens for a plurality of terminal apparatuses on the divided screens in response to pieces of home screen information being received from the plurality of terminal apparatuses.

According to an aspect of another exemplary embodiment, there is provided a non-transitory computer-readable recording medium storing a program that is executable by a computer for performing a method for controlling a display apparatus which is connectable to at least one terminal apparatus. The method may include: receiving home screen information from the at least one terminal apparatus; and generating a home screen based on the received home screen information and displaying the home screen on the display of the display apparatus.

### BRIEF DESCRIPTION OF THE DRAWINGS

The above and/or other aspects will be more apparent by describing in detail exemplary embodiments, with reference to the accompanying drawings, in which:

FIG. 1 is a block diagram illustrating a display apparatus according to an exemplary embodiment;

FIG. 2 is a view explaining an operation of editing a type or an arrangement of content according to an exemplary embodiment;

FIGS. 3 and 4 are view illustrating UIs for setting a connection state to a terminal apparatus;

FIG. 5 is a view illustrating a method of generating a home screen using one piece of information among pre-stored home screen information according to an exemplary embodiment;

FIG. 6 is a view illustrating an example in which a display apparatus matches a terminal apparatus in an N:N correspondence manner according to an exemplary embodiment;

FIG. 7 is a flowchart illustrating a method for controlling a display apparatus according to an exemplary embodiment; and

FIGS. 8 and 9 are views illustrating examples in which a display apparatus matches a terminal apparatus in an N:1 correspondence manner according to another exemplary embodiment.

### DETAILED DESCRIPTION OF EXEMPLARY EMBODIMENTS

Hereinafter, exemplary embodiments will be described in more detail with reference to the accompanying drawings.

In the following description, the same reference numerals are used for the same elements when they are depicted in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, functions or elements known in the related art are not described in detail since they may obscure the exemplary embodiments with unnecessary detail.

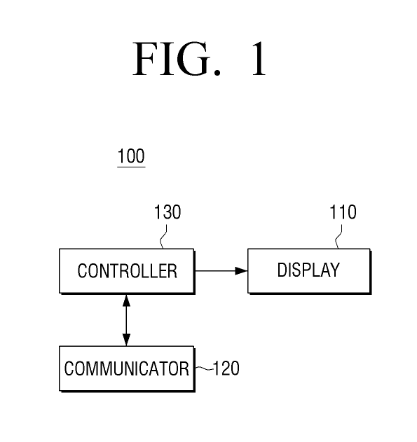

FIG. 1 is a block diagram illustrating a display apparatus 100 according to an exemplary embodiment. Referring to FIG. 1, the display apparatus 100 includes a display 110, a communicator 120, and a controller 130.

Only components related to the exemplary embodiment are illustrated in the display apparatus 100 of FIG. 1. Therefore, those skilled in the related art of the exemplary embodiment may understand that other general-purpose components may be further included in addition to the components illustrated in FIG. 1.

The display apparatus 100 illustrated in FIG. 1 may be an integrated smart TV, a removable smart TV, or an IP TV, but the display apparatus is not limited thereto. Hereinafter, for clarity, it will be described that the display apparatus 100 may be a smart TV which provides Internet-based bidirectional services. However, the display apparatus is not limited thereto, and those skilled in the related art of the exemplary embodiment may understand that the display apparatus 100 may be a display apparatus which provides functions such as Internet-based web surfing, VOD viewing, SNS, or game.

The display 110 displays a screen corresponding to web surfing, VOD watching, SNS, or a game selected by the user. The display 110 may divide one screen into a plurality of screens, and display web surfing, VOD watching, and the like selected by a plurality of users on the respective divided screens. Further, the display 110 may display various user interface (UI) screens for setting various functions.

In response to the display apparatus 100 being turned on by the user or a home button being pressed by an operation device such as a remote controller, a home screen in which icons, which executes various functions or various pieces of content supported by the display apparatus 100, are displayed is provided.

The user may select one of a plurality of pieces of content displayed in the home screen to view the corresponding content or to execute a desired widget program or the like.

The communicator 120 receives home screen information (edition information) from a terminal apparatus connected to the display apparatus 100.

Here, the home screen information may be information for types of a plurality of pieces of content displayed in the home screen or an arrangement state of content. For example, the home screen information may be information regarding a type or types of content among various pieces of contents provided by the display apparatus 100 to be displayed or information for an arrangement structure of preferentially displayed content.

The home screen information may have been edited in a terminal apparatus connected to the display apparatus.

The communicator 120 is configured to connect the display apparatus 100 to a terminal apparatus, and the display apparatus 100 may be connected to the terminal apparatus in a wireless or wired manner through a local area network (LAN) and an Internet network as well as an NFC tag manner of the Institute of Electrical and Electronic Engineers (IEEE) 802.15.4 standard which supports short-range communication such as Bluetooth or Zigbee. Hereinafter, for clarity, the example in which the display apparatus 100 is connected to the terminal apparatus in an NFC tag manner is illustrated.

The NFC tag is one of radio frequency identification (RFID) techniques, and is non-contact communication technology which uses a frequency band of 13.56 MHz. Since the NFC tag has relatively good security due to a short communication distance and is low-priced, the NFC tag is one of spotlighted short-range communication techniques, and is advantageous to read and write data and to perform communication without setup between apparatuses like Bluetooth.

In response to a terminal apparatus being a smart phone, and the terminal apparatus and the display apparatus 100 including NFC tags, the display apparatus 100 and the terminal apparatus which are located within a certain distance may automatically recognize each other, and receive and transmit data.

The controller 130 generates a home screen based on the home screen information received from the communicator 120, and displays the generated home screen in the display 110.

For example, a user “A” may previously edit a type or an arrangement of content to be displayed in a home screen of a smart TV using a previously installed application in a smart phone of the user, and store home screen information in the smart phone.

Then, in response to a terminal apparatus of the user and the display apparatus 100 being connected using the NFC tags included in the terminal apparatus and the display apparatus 100, and the information for the type or arrangement of content which has been previously edited, that is, the home screen information being transmitted to the display apparatus 100, the display apparatus 100 generates the home screen based on the home screen information, and provides the home screen to the user.

Similarly, in response to information for a type and an arrangement of content which have been previously edited by another user “B” being transmitted to the display apparatus 100 using the NFC tag, the display apparatus 100 may provide another home screen based on the information.

Therefore, the effect that the user may receive service by previously editing a home screen matching a user's taste in a smart phone of the user and transmitting the home screen information to a smart TV may be obtained.

Further, difficulty in activating a separate setup menu to edit a home screen in a smart TV may be avoided.

In response to a home screen of the user A being generated and provided to the user A, and the user B requesting a home screen to be provided, the display apparatus 100 according to an exemplary embodiment may divide the screen and display the home screen of the user A and the home screen of the user B in the divided screens, respectively.

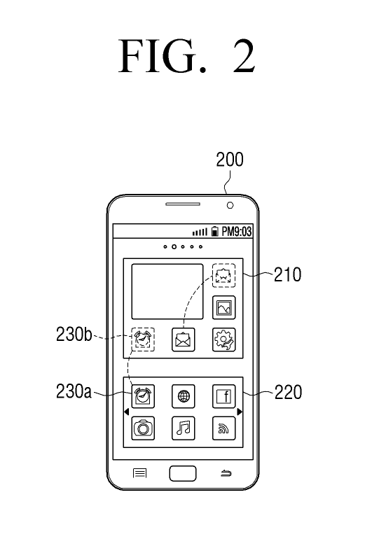

FIG. 2 is a view explaining an operation of editing a type or an arrangement of content according to an exemplary embodiment.

A terminal apparatus 200 illustrated in FIG. 2 is an external apparatus which is connectable to the display apparatus 100, and may be implemented by a smart phone, a tablet personal computer (PC), a laptop computer, a personal digital assistant (PDA), or the like. Hereinafter, for clarity, an example that the terminal apparatus 200 is a smart phone will be described.

An application for editing a home screen provided by a manufacturer of the display apparatus 100 may have been installed in the terminal apparatus 200. In response to the application being executed, a home screen 210 of the display apparatus and a screen 220 in which a plurality of pieces of content are displayed on the terminal apparatus 200.

A virtual home screen of the display apparatus 100, which is to be set by the user, is displayed in the home screen 210 of the terminal apparatus 200. The virtual home screen of the display apparatus 100 is a screen displayed in response to the display apparatus 100 being executed, and a TV screen which is currently broadcast or various pieces of content supported by the display apparatus 100 is displayed in the home screen. The content may include VOD service, web service, a game, an application, or the like.

The user may edit an arrangement of the content in the home screen 210 of the terminal apparatus 200. For example, in response to an Internet icon at a lower portion of the home screen 210 of the terminal apparatus 200 being drawn toward an upper portion of the home screen 210 in a drag and drop manner, a location of the Internet icon is changed.

Similarly, arrangements of other icons may be edited through the above-described method. The exemplary embodiment has described that the icon arrangement is edited through the drag and drop operation, but the icon arrangement may be edited using a physical direction key provided in the terminal apparatus 200.

The arrangement of content displayed in the home screen 210 of the terminal apparatus 200 as well as a type of the displayed content may be edited.

A plurality of pieces of content which may be executed in the display apparatus 100 may be displayed in the screen 220. The user may select content which is to be used by the user or is frequently used by the user, and move the selected content to the home screen 210 of the display apparatus in a drag and drop manner. Similarly, the exemplary embodiment has exemplified to move the content icon from the screen 220 in which the plurality of pieces of content are displayed to the home screen 210 of the terminal apparatus 200 in the drag and drop manner. However, the content icon may be edited using a physical direction key provided in the terminal apparatus 200.

Information for the home screen 210 of the display apparatus 100 edited in the terminal apparatus 200 by the user is transmitted to the display apparatus 100. Therefore, the same screen as the home screen 210 of the display apparatus 100 edited through the terminal apparatus 200 by the user is displayed in the display apparatus 100.

In response to a plurality of users, for example, a father and a son requesting the home screens 210 through terminal apparatuses 200 thereof in home in the above-described process, the display apparatus may determine whether the plurality of users request the home screens 210, and then divide the screen according to a determination result and provide the home screens 210 in the divided screens. For example, the screen may be divided into two screens, three screens, or four screens in a preset manner according to the number of users. For example, in response to the number of users being two and the preset method being a left and right division manner, the display apparatus may determine whether the preset method is the left and right division manner, and display the home screens 210 of the two users in the left-side screen and the right-side screen. However, the display method may be variously modified, and thus the display method is not limited thereto.

Therefore, the user may obtain the effect that may easily edit the type and arrangement of the content displayed in the home screen in the terminal apparatus 200 without editing the type and arrangement of the content displayed in the home screen through a separate setup menu in the display apparatus 100.

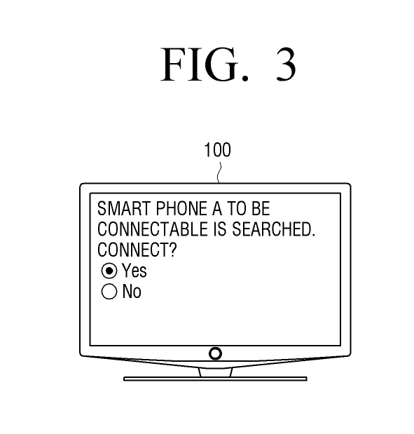

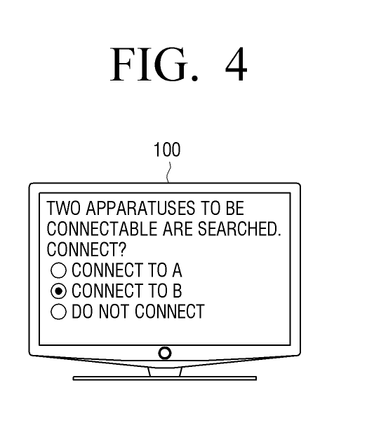

FIGS. 3 and 4 are views illustrating UIs for setting a connection state to a terminal apparatus.

For clarity, referring to FIGS. 3 and 4 with FIG. 1, the controller 130 may provide a UI for setting a connection state to the terminal apparatus. The display 110 displays the UI generated through the controller 130.

In response to the communicator 120 being implemented with an NFC tag, the communicator 120 may connect the terminal apparatus to the display apparatus 100 even without a separate setup between apparatuses in response to the user bringing the terminal apparatus in contact with the communicator 120.

At this time, the controller 130 of the display apparatus 100 may generate a UI inquiring whether to connect a searched terminal apparatus to the display apparatus and display the UI on the display 110. In response to “YES” being selected on the UI by the user, the display apparatus receives home screen information which has been previously edited by the user from the terminal apparatus, generates a home screen based on the received home screen information, and provides the home screen to the user.

Further, as illustrated in FIG. 4, a plurality of terminal apparatuses which are connectable to the display apparatus may exist around the display apparatus 100. In this situation, the controller 130 may generate a UI that is displayed on the display 110 and lists the plurality of connectable terminal apparatuses and allows the user to select a terminal apparatus to be connected.

In response to one terminal apparatus among the plurality of terminal apparatuses connected to the display apparatus 100 being selected by the user, the display apparatus may generate a home screen based on home screen information received from the selected terminal apparatus and display the home screen on the display 110.

Alternatively, in response to “NO” being selected with respect to a connection state to the terminal apparatus by the user, the display apparatus may not receive information for a type and an arrangement of content from the terminal apparatus, and thus the display apparatus provides a home screen set to default to the user.

Even in response to “YES” being selected with respect to the connection state to the terminal apparatus by the user, the display apparatus provides the home screen set to default to the user in response to failing to receive the home screen information from the terminal apparatus.

The display apparatus 100 may further include a storage 140 configured to store the home screen information received from the terminal apparatus. Therefore, even in response to the terminal apparatus being not connected to the display apparatus 100, the display apparatus 100 may generate a home screen based on the home screen information which is previously received from the terminal apparatus and stored in the storage 140, and display the home screen.

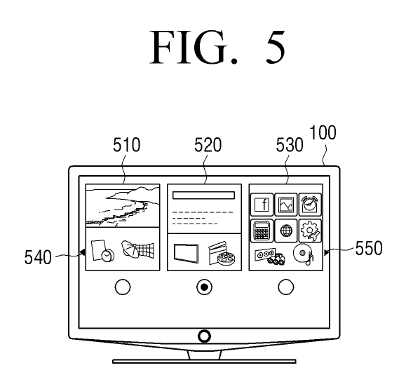

FIG. 5 is a view illustrating an operation of generating a home screen using one piece of information among pre-stored home screen information according to an exemplary embodiment.

The display apparatus 100 may generate a plurality of home screens 510, 520, and 530 based on a plurality of pieces of home screen information pre-stored in the storage 140, and allow the user to select a desired home screen. The exemplary embodiment of FIG. 5 shows three home screens 510, 520, and 530 are provided based on the plurality of pieces of pre-stored home screen information, but more or less home screens may be provided.

The user may select a home screen displayed in next screen by selecting direction keys 540 and 550 displayed in the display 110.

In response to the home screen information received from the terminal apparatus being stored, and the home screen being generated based on the stored home screen information and provided to the user as described above, the effect that the home screen, in which the user's taste is reflected, may be provided may be obtained even in response to the display apparatus 100 being not connected to the terminal apparatus in a wired or wireless manner.

In the above-described exemplary embodiment, only one among a plurality of pieces of pre-stored home screen information is selected. However, a plurality of pieces of information among the plurality of pieces of pre-stored home screen information may be selected. In this case, the display apparatus may divide the screen and display home screens in the divided screens.

In response to receiving home screen information from the terminal apparatus and providing the home screen according to an exemplary embodiment, the display apparatus 100 may match the terminal apparatus in N:N correspondence manner, and thus the effect that the home screen, in which the user's taste is considered, may be provided to a TV in the home of the user as well as other display apparatuses 100 may be obtained.

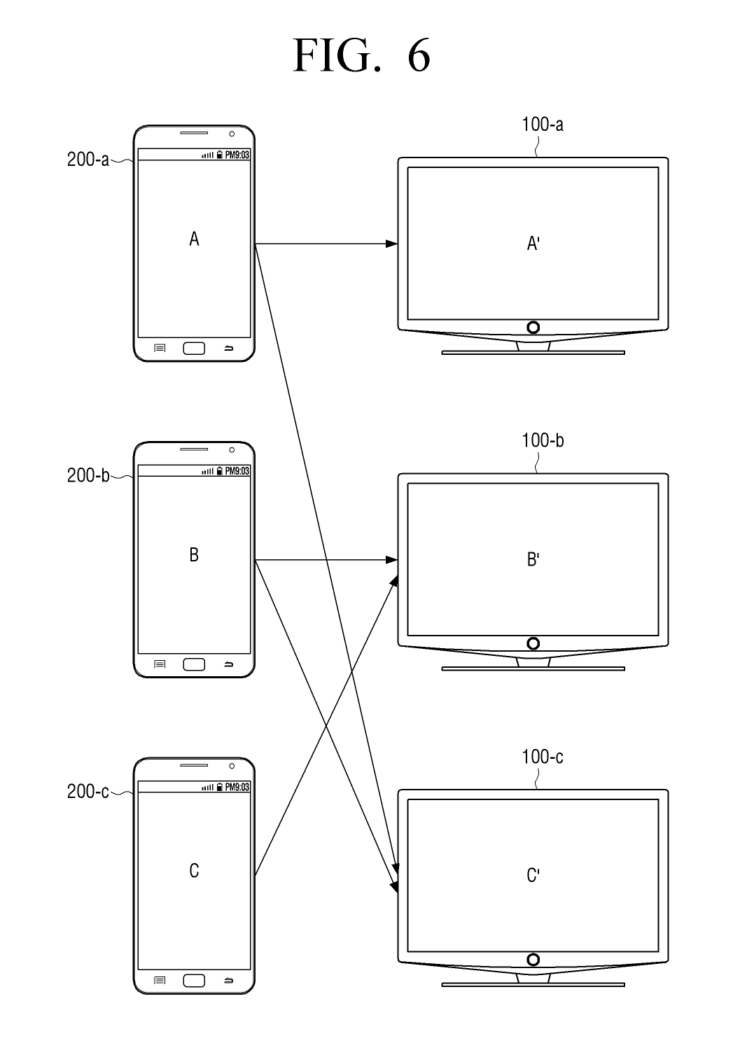

FIG. 6 is a view illustrating an example in which a display apparatus matches a terminal apparatus in an N:N correspondence manner according to an exemplary embodiment.

The exemplary embodiment has exemplified that three terminal apparatuses 200-a, 200-b, and 200-c match three display apparatuses 100-a, 100-b, and 100-c, but a plurality of terminal apparatuses may be implemented to match a plurality of display apparatuses.

In response to a terminal apparatus A 200-a transmitting home screen information to a display apparatus C′ 100-c, a user who uses the terminal apparatus A 200-a may receive a home screen according to the user's taste from the display apparatus C′ 100-c.

In response to the user who uses the terminal apparatus A 200-a requesting to receive only his own home screen from the display apparatus A′ 100-a located in a different place from a display apparatus C′ 100-c, the user may transmit home screen information edited in the terminal apparatus A 200-a to the display apparatus A′ 100-a, and receive only his own home screen of the user.

A user of a terminal apparatus B 200-b and a user of a terminal apparatus C 200-c may also transmit home screen information in the terminal apparatuses to the display apparatuses and receive home screens matching the tastes of the users regardless of places in which the display apparatuses are located.

In response to the home screen being received by editing the home screen in the terminal apparatus having good mobility and transmitting the home screen information to the display apparatus as in the exemplary embodiment, the effect that the user satisfaction may be improved by receiving the home screen matching the user's taste without limitations of a place in which the user is located or time may be obtained.

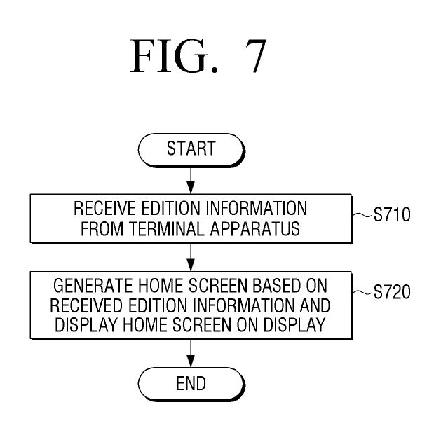

FIG. 7 is a flowchart illustrating a method of controlling a display apparatus according to an exemplary embodiment.

The user edits a type of content to be displayed in a home screen of the display apparatus 100 and an arrangement of the content using an application previously installed in a terminal apparatus. Then, in response to the terminal apparatus being connected to the display apparatus 100 in a wireless or wired manner, the display apparatus 100 receives home screen information from the terminal apparatus (S710).

In response to the terminal apparatus being a smart phone and including an NFC tag, the display apparatus 100 may automatically recognize the terminal apparatus located within a certain distance and transmit and receive data. At this time, the display apparatus 100 may receive the home screen information from the terminal apparatus.

The display apparatus 100 which receives the home screen information from the terminal apparatus generates a home screen based on the received home screen information and displays the home screen on the display to be viewed by the user (S720). Further, the received home screen information is stored in the storage 140 included in the display apparatus 100, and the display apparatus 100 may generate the home screen based on the home screen information stored in the storage 140 and display the home screen to the user even in response to the terminal apparatus being not connected to the display apparatus 100 in a wired or wireless manner.

As described above, in response to the home screen information edited in the terminal apparatus being received, and the home screen being generated and displayed to the user, the effect that the home screen, in which the user's taste is considered, may be provided regardless of the location in which the user is located or time may be obtained.

Further, the need to enter a separate setup menu in order for the user to set the home screen displayed in an initial screen of the display apparatus 100 may be eliminated.

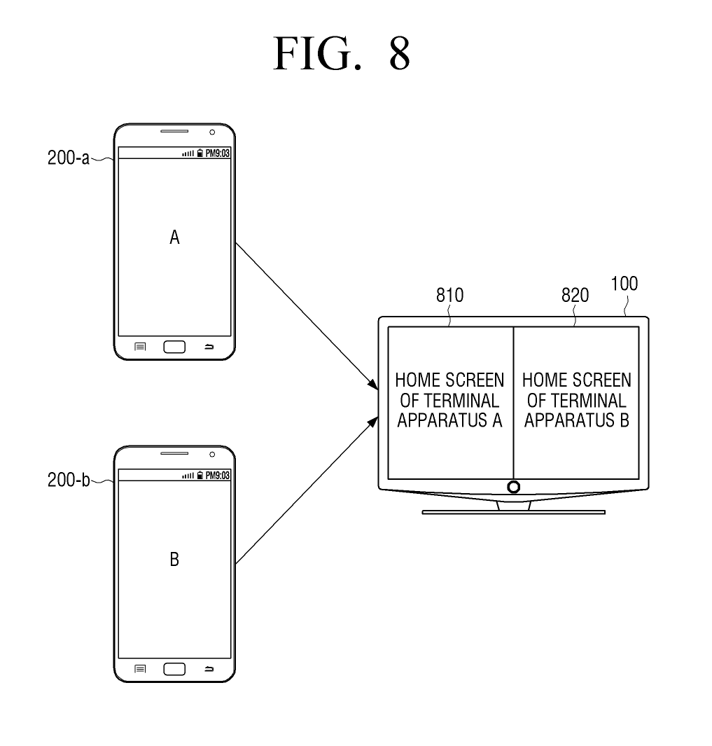

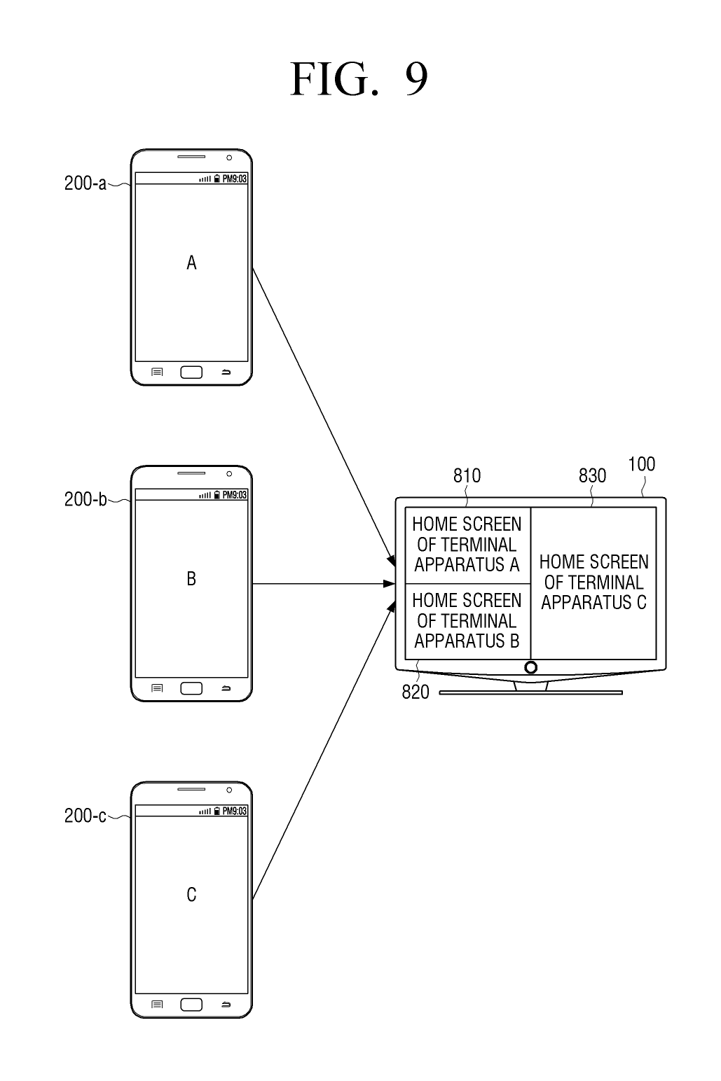

FIGS. 8 and 9 are views illustrating examples in which a display terminal and a terminal apparatus match in an N:1 correspondence manner according to another exemplary embodiment.

Referring to FIGS. 8 and 9, a display apparatus 100 according to another exemplary embodiment may configure home screens (810 and 820 in FIG. 8, and 810, 820, and 830 in FIG. 9) by dividing a screen according to the number of information provided from a plurality of terminal apparatuses (200-a and 200-b in FIG. 8, and 200-a, 200-b, and 200-c in FIG. 9).

For example, in response to home screen information being provided from the terminal apparatus B 200-b in a state in which the display apparatus 100 configures a home screen on a full screen (that is, the home screen on one screen according to home screen information provided from the terminal apparatus A 200-a), the display apparatus 100 may determine whether the home screen information is provided in the state, and then divide the screen into left and right screens according to a preset manner and display the home screens 810 and 820 according to a determination result as illustrated in FIG. 8. The preset division method may include an upper and lower screen division method or the like, other than the left and right screen division method. In response to home screen information being provided even from the terminal apparatus C 200-c, the display apparatus 100 may determine whether the home screen information is provided, and then divide the screen according to a preset manner and display the home screens 810, 820 and 830 according to a determination result as illustrated in FIG. 9. For example, to divide the screen according to the exemplary embodiment, pixel data has to be divided in a source driver and provided, and thus an independent control of the home screens 810 to 830 may be possible. The screen division according to the exemplary embodiment may be similar to picture-in-picture (PIP) which synthesizes pixel data.

The display apparatus 100 may additionally perform various determination operations in addition to the above-described determination operation. In other words, the display apparatus 100 may determine whether to divide the screen according to whether the terminal apparatuses 200-a, 200-b, and 200-c providing home screen information are apparatuses of normal users previously registered. Further, in response to the screen being preset to be divided into maximum two screens by the user, the display apparatus 100 may divide the screen according to the order of the input home screen information, and display the home screens. In response to the home screen information or the terminal apparatuses 200-a, 200-b, and 200-c in which the priorities are preset existing, the display apparatus may divide the screen according to the priority. In addition, various modifications may be possible, and thus the exemplary embodiment is not limited thereto.

Further, although the method of dividing the screen and displaying the home screens in the divided screens in the display apparatus 100, that is, the driving method of the display apparatus 100 is not specifically shown in the drawings, the method may be sufficiently supported by FIGS. 8 and 9 and the detailed description thereof, and thus further description will be omitted.

According to the exemplary embodiments, a home screen may be edited to the personal taste of the user and provided to the user.

The above-described method may be embodied in a program or code which may be stored in a non-transitory computer-readable recording medium and executed by a computer or processor, and may be implemented in a general-purpose digital computer which executes the program using the computer-readable recording medium. Further, the structure of data used in the above-described method may be recorded in the computer-readable recording medium through various units. The computer-readable recording medium may include a magnetic storage medium (for example, a read only memory (ROM), a floppy disc, a hard disc, or the like), and an optically readable medium (for example, a compact disc (CD) ROM, a digital versatile disc (DVD), or the like).

The foregoing exemplary embodiments and advantages are merely exemplary and are not to be construed as limiting the present inventive concept. The exemplary embodiments can be readily applied to other types of devices. Also, the description of the exemplary embodiments is intended to be illustrative, and not to limit the scope of the claims, and many alternatives, modifications, and variations will be apparent to those skilled in the art.

What is claimed is:

1. A display apparatus comprising:
a display;
a communicator configured to receive home screen information from at least one terminal apparatus; and
a controller configured to generate a home screen based on the received home screen information and control the display to display the generated home screen.

2. The display apparatus as claimed in claim 1, wherein the home screen information is information regarding a type of at least one piece of content displayed on the home screen or an arrangement state of the content displayed on the home screen.

3. The display apparatus as claimed in claim 1, further comprising a storage configured to store the home screen information received from the terminal apparatus.

4. The display apparatus as claimed in claim 3, wherein the controller is configured to generate a user interface configured to select a home screen from among a plurality of home screens corresponding to a plurality of pieces of home screen information stored in the storage, and control the display to display the user interface.

5. The display apparatus as claimed in claim 1, wherein the controller is configured to generate a user interface configured to set a connection state to the at least one terminal apparatus, and control the display to display the user interface.

6. The display apparatus as claimed in claim 1, wherein the controller is configured to generate a user interface configured to select a terminal apparatus, which is to receive the home screen information, from the at least one terminal apparatus, and control the display to display the user interface.

7. The display apparatus as claimed in claim 1, wherein the controller is configured to control the display to display a home screen set to default in response to the home screen information being not received from the terminal apparatus.

8. The display apparatus as claimed in claim 1, wherein the communicator is a near field communication tag.

9. The display apparatus as claimed in claim 1, wherein the controller is configured to control the display to divide a screen of the display and to display home screens for a plurality of terminal apparatuses in the divided screens in response to pieces of home screen information being received from the plurality of terminal apparatuses.

10. A method for controlling a display apparatus which is connectable to at least one terminal apparatus, the method comprising:
receiving, by the display apparatus, home screen information from the at least one terminal apparatus;
generating a home screen based on the received home screen information; and
displaying the home screen on a display of the display apparatus.

11. The method as claimed in claim 10, wherein the home screen information is information regarding a type of at least one piece of content displayed on the home screen or an arrangement state of the content displayed on the home screen.

12. The method as claimed in claim 10, further comprising storing the home screen information received from the terminal apparatus in a storage of the display apparatus.

13. The method as claimed in claim 12, further comprising displaying a user interface configured to select a home screen from among a plurality of home screens corresponding to a plurality of pieces of home screen information stored in a storage of the display apparatus.

14. The method as claimed in claim 10, further comprising displaying a user interface configured to set a connection state to the at least one terminal apparatus.

15. The method as claimed in claim 10, further comprising providing a user interface configured to select a terminal apparatus, which is to receive the home screen information, from the at least one terminal apparatus.

16. The method as claimed in claim 10, further comprising determining whether the home screen information is received from the at least one terminal apparatus,
wherein the generating the home screen and the displaying the home screen on the display includes generating and displaying a home screen set to default in response to the home screen information being not received from the at least one terminal apparatus.

17. The method as claimed in claim 10, wherein the receiving the home screen information from the terminal apparatus includes receiving the home screen information in a near field communication tag.

18. The method as claimed in claim 10, wherein the displaying the home screen on the display includes dividing a screen of the display and displaying home screens for a plurality of terminal apparatuses on the divided screens in response to pieces of home screen information being received from the plurality of terminal apparatuses.

19. A computer-readable recording medium storing a program that is executed by a computer to perform a method for controlling a display apparatus which is connectable to at least one terminal apparatus, the method comprising:
receiving home screen information from the at least one terminal apparatus;
generating a home screen based on the received home screen information; and
displaying the home screen on a display of the display apparatus.
